(19) United States
(12) Patent Application Publication
(10) Pub. No.: US 2012/0082078 A1
(43) Pub. Date: Apr. 5, 2012

(54) COMMUNICATION APPARATUS, METHOD AND PROGRAM FOR CONTROLLING SAME

(75) Inventor: Fumihide Goto, Naka-gun (JP)

(73) Assignee: CANON KABUSHIKI KAISHA, Tokyo (JP)

(21) Appl. No.: 13/218,997

(22) Filed: Aug. 26, 2011

(30) Foreign Application Priority Data
Oct. 1, 2010 (JP) 2010-224371
Jul. 14, 2011 (JP) 2011-155950

(51) Int. Cl. H04W 52/02

(52) U.S. Cl. 370/311

(57) ABSTRACT

If periodic processing in a higher-layer protocol control unit occurs in a case where a wireless LAN control unit is in a power saving mode, there is a high probability that the higher-layer protocol control unit will time out and that communication will be severed. Accordingly, the present invention arranges it so that respective timer values are changed dynamically in such a manner that periodic processing in the higher-layer protocol control unit and a sleep state in the power saving mode will not conflict with each other.

### BACKGROUND OF THE INVENTION

1. Field of the Invention

The present invention relates to a communication apparatus, a method of controlling the communication apparatus and a program for controlling the apparatus.

2. Description of the Related Art

Use of wireless LAN (Local Area Network) systems represented by IEEE (Institute of Electrical and Electronics Engineers) 802.11 has become widespread in recent years.

A wireless LAN system generally is constituted by an access point (referred to as a base station below) and a station (referred to as a terminal station below) that is present within the range of radio waves arriving from the base station and that is wirelessly connected to the base station.

Further, a wireless LAN system is such that the network is controlled by the base station. Specifically, the base station issues an alert signal referred to as a “beacon” within the network periodically, whereby the terminal station acquires an identifier relating to the network as well as security information and the like.

In accordance with IEEE Std 802.11, the terminal station within the network is capable of shifting to a power saving mode, in which operation is performed intermittently, in cases where the sending and receiving of data is unnecessary, thereby making it possible to reduce power consumption. Specifically, a transition is made to a state in which the power supplied to the receiver is shut down (this state will be referred to as a “doze state” or “sleep state” below) until a time at which the next beacon is received or a beacon a plurality of cycles ahead is received. When the planned beacon reception time draws near, a transition is made to a state in which power is supplied to the receiver autonomously (this state is referred to as the “awake state” or “normal state” below) so that data can be sent and received as necessary.

On the other hand, in a case where it is desired to shift the base station to the power saving mode, the problem set forth below arises at execution of higher-layer protocol processing (periodic processing according to the protocol of a higher layer) such as encryption-key exchange control processing performed under the initiative of the base station.

For example, in a case where an attempt is made to transmit a packet periodically by higher-layer protocol processing, the packet cannot be transmitted if processing based upon a lower-layer protocol is in the sleep state at the timing at which the packet is to be transmitted. According to the higher-layer protocol processing in this case, a response-packet standby state is established despite the fact that a packet has not been transmitted. The result is that a timeout occurs and execution of the higher-layer protocol processing cannot continue.

Furthermore, depending upon the type of higher-layer protocol processing, it may be arranged so that the wireless LAN connection between the base station and the terminal station may itself be severed if the above-described situation occurs. It should be noted that the above-described situation can occur in similar fashion not only on the side of a communication apparatus that constructs and controls a network by acting as a base station but also in a case where a communication apparatus that operates as a terminal station transmits a packet.

### SUMMARY OF THE INVENTION

The present invention has been devised in view of the circumstances described above. A communication apparatus according to the present invention comprises: a power saving unit configured to cause a wireless communication section to transition to a power saving state and an awake state periodically; a communication unit configured to execute wireless communication by a prescribed protocol periodically; and a changing unit configured to change, in accordance with execution timing at which wireless communication by the prescribed protocol is executed periodically and transition timing at which the wireless communication section is caused to transition from the power saving state to the awake state, either the execution timing or the transition timing before wireless communication by the prescribed protocol is executed periodically.

In accordance with the present invention, in a case where a packet is transmitted periodically in a communication apparatus that communicates according to a predetermined protocol, it is possible for communication according to this protocol to continue without conflict with a sleep state established by a power saving mode.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram illustrating the hardware configuration of a communication apparatus;

FIG. 2 is a block diagram illustrating a communication control function executed in a communication apparatus;

FIG. 3 is a diagram illustrating a network arrangement constructed by a communication apparatus;

FIG. 4 is a sequence diagram illustrating operating sequences of a communication apparatus A and a communication apparatus B in a power saving mode;

FIG. 5A is a sequence diagram illustrating the ordinary operating sequences of a key exchange layer and wireless layer in a communication apparatus A and a communication apparatus B;

FIG. 5B is a flowchart illustrating ordinary key exchange control processing in a key exchange layer;

FIG. 6A is a sequence diagram illustrating the operating sequences of a key exchange layer and wireless layer in a communication apparatus A and a communication apparatus B according to a first embodiment;

FIG. 6B is a flowchart illustrating key exchange control processing that takes into consideration a sleep state in a key exchange layer;

FIGS. 7A and 7B are sequence diagrams illustrating operating sequences of a higher-layer protocol layer and wireless layer in a communication apparatus A and a communication apparatus B according to a second embodiment;

FIG. 8 is a flowchart illustrating ordinary key exchange control processing in a wireless layer;

FIG. 9 is a flowchart illustrating key exchange control processing that takes into consideration a key exchange period in a wireless layer; and

FIG. 10 is a flowchart illustrating key exchange control processing that takes into consideration a key exchange period in a wireless layer.

### DESCRIPTION OF THE EMBODIMENTS

Embodiments of the present invention will now be described in detail in accordance with the accompanying drawings.

It should be noted that although an example using a wireless LAN system compliant with the IEEE 802.11 series will be described below, the present invention is not necessarily limited to a wireless LAN system compliant with IEEE 802.11.

### First Embodiment

### <1. Hardware Configuration of Communication Apparatus>

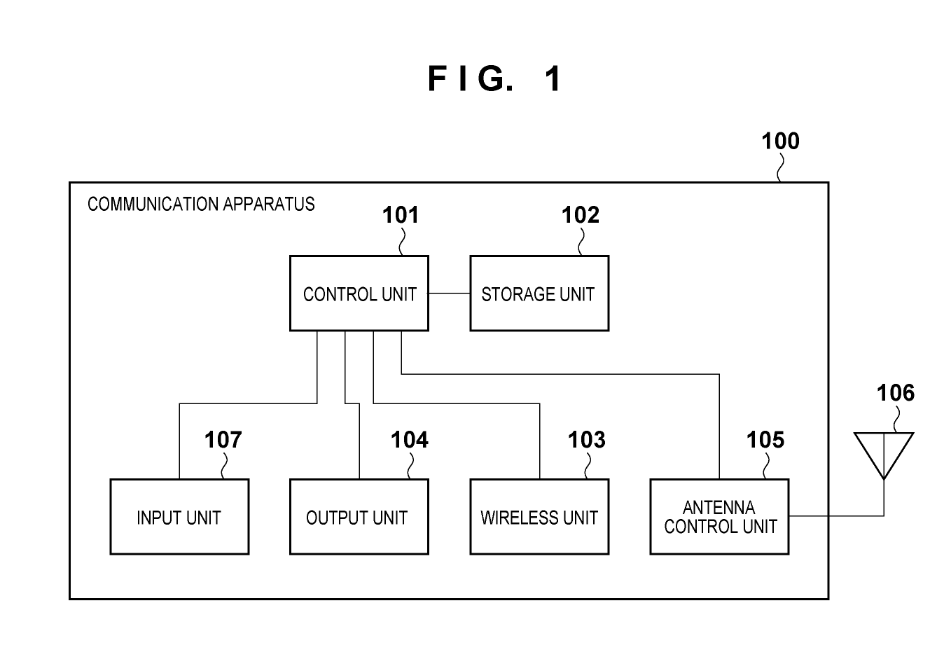

The hardware configuration of a communication apparatus according to an embodiment of the present invention will now be described. FIG. 1 is a block diagram illustrating the hardware configuration of a communication apparatus 100 according to an embodiment of the present invention.

As shown in FIG. 1, a control unit 101 controls the communication apparatus 100 by executing various control programs stored in a storage unit 102. The storage unit 102 stores various programs executed in the control unit 101 and stores various information such as communication parameters.

A wireless unit 103 is for performing wireless LAN communication compliant with the IEEE 802.11 series. An output unit 104 delivers various outputs and has functions such as a display function for outputting visually recognizable information using an LCD or LED or the like, and an audio output function for outputting aurally recognizable information using a speaker or the like. It is assumed that the output unit 104 in this embodiment is equipped with at least either of the display function or audio function.

The communication apparatus 100 further includes an antenna control unit 105, an antenna 106 and an input unit 107 for allowing a user to perform various inputs.

### <2. Configuration of Function Blocks>

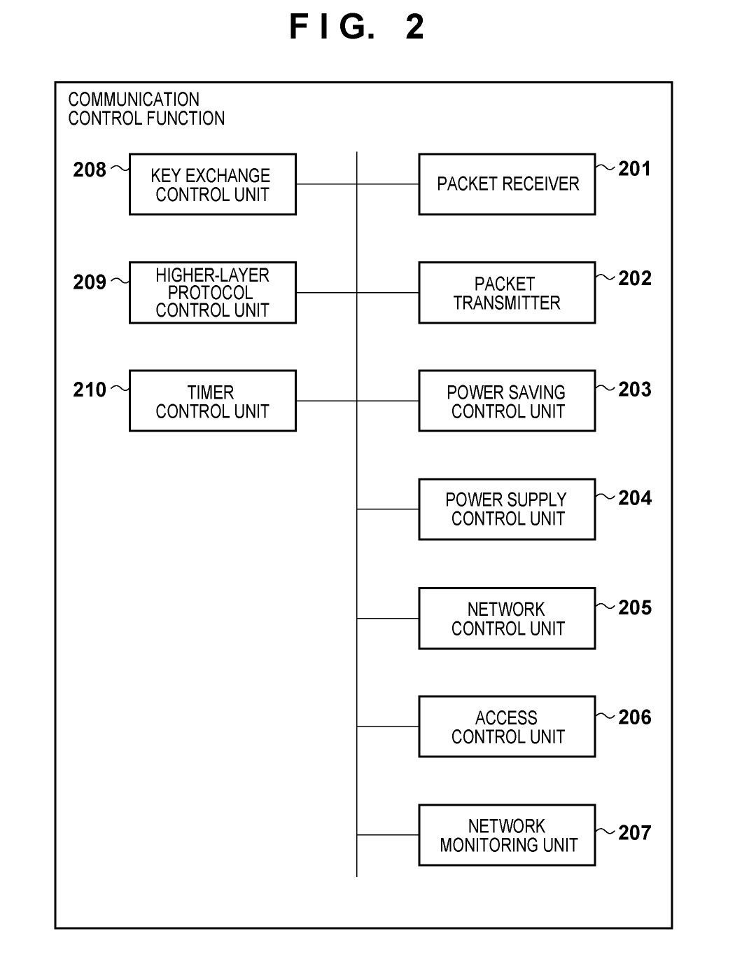

FIG. 2 is a block diagram illustrating the functional configuration of a communication control function implemented in the communication apparatus 100 (implemented by the above-described hardware, or implemented by having the above-mentioned control program run by the control unit 101, or by cooperation between both of these).

As shown in FIG. 2, a packet receiver 201 outputs a packet, which has been received from another communication apparatus, to a key exchange control unit 208 and higher-layer protocol control unit 209. A packet transmitter 202 transmits a packet, which has been output from the key exchange control unit 208 or higher-layer protocol control unit 209, etc., to another communication apparatus.

A power saving control unit 203 is for shifting this communication apparatus to the power saving mode and for sending another communication apparatus notification of the power saving mode. A power supply control unit 204 controls the power supply of this communication apparatus. Mainly, the power supply of the hardware of this communication apparatus is turned on and off by a command from the power saving control unit 203.

A network control unit 205 controls the network connection. Processing such as processing for connecting to the network is executed by the network control unit 205.

The key exchange control unit 208 executes encryption-key exchange control processing (referred to as key exchange control processing below) by which an encryption key is exchanged between this communication apparatus and another communication apparatus. It should be noted that it is assumed that the key exchange control unit 208 in this embodiment executes key exchange control processing that is based upon WPA (registered trademark) specifications or IEEE 802.11i specifications.

The higher-layer protocol control unit 209 executes various control processing by a communication protocol in a layer higher than the wireless layer, examples being an addressing function such as DHCP or AutoIP or a discovery function such as UPnP.

A timer control unit 210 controls a timer, which is for managing timeout, etc., of various protocols, in key exchange control processing by the key exchange control unit 208 and control processing by the higher-layer protocol control unit 209. In this embodiment, it is assumed that the network control unit 205 is arranged so as to sever the connection to the wireless network if timeout occurs in the key exchange control processing or in control processing by the communication protocol in the higher layer.

An access control unit 206 executes processing, such as filtering of MAC address information, for controlling the enabling and disabling of wireless communication. It should be noted that it is assumed that MAC address information to which reference is had in filtering has been stored in the storage unit 102.

A network monitoring unit 207 provides a network monitoring function such as the management of information regarding another apparatus that is wirelessly connected to this communication apparatus in a case where this communication apparatus operates as a base station.

It should be noted that the above-mentioned function blocks illustrate one example, and it may be arranged so that a plurality of function blocks form a single function block or so that any function block is divided into a plurality of function blocks.

### <3. Configuration of Wireless Network>

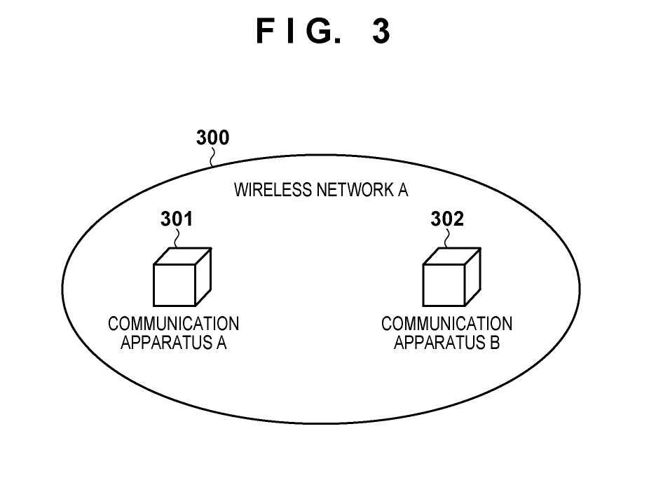

FIG. 3 is a diagram illustrating a wireless network 300 (referred to as “wireless network A” below) constituted by a communication apparatus 301 (referred to as “communication apparatus A” below) and a communication apparatus 302 (referred to as a “communication apparatus B below) having the hardware configuration shown in FIG. 1 and capable of implementing the communication control function shown in FIG. 2.

In the example of FIG. 3, it is assumed that the communication apparatus A operates as a base station in the wireless network A and that the communication apparatus B operates as a terminal station wirelessly connected to the communication apparatus A. In the example of FIG. 3, a case where a communication apparatus that operates as a wireless terminal is a single wirelessly connected communication apparatus is illustrated. However, more than one communication apparatus may be wirelessly connected as a temperature coefficient.

### 4. Operating Sequence in Power Saving Mode of Each Communication Apparatus>

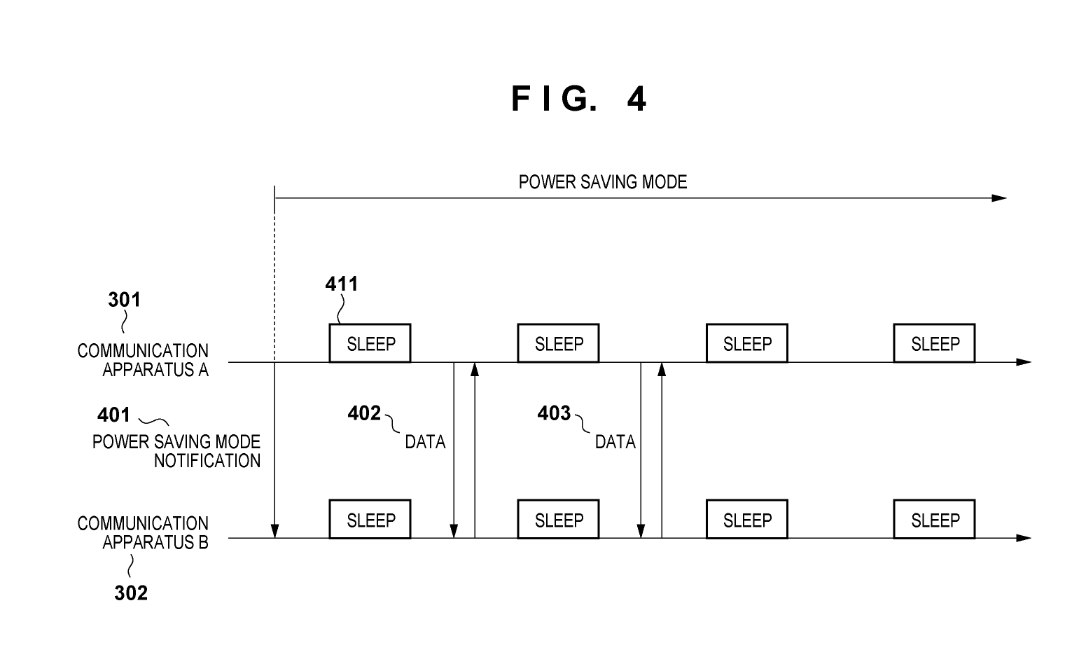

Reference will be had to FIG. 4 to describe the operating sequence in the wireless network A in a case where the communication apparatus A and communication apparatus B operate in the power saving mode.

As illustrated in FIG. 4, when a transition is made to the power saving mode, first the communication apparatus A serving as the base station transmits a signal (power saving mode notification 401) to the communication apparatus B, which serves as the terminal station, to indicate to this apparatus that it is to shift to the power saving mode. Using transmission of the power saving mode notification 401 as a trigger, the communication apparatus A and the communication apparatus B shift to the power saving mode and transition to the sleep state at prescribed time intervals. In other words, from this point onward the normal state and the sleep state (411) repeat alternatingly periodically. It should be noted that the sending and receiving of data between the communication apparatuses after the shift to the power saving mode is executed in the normal state between the sleep states (see 402 and 403).

### <5. Ordinary Operating Sequences and Processing Flow in Key Exchange Control Processing of Each Layer After Each Communication Apparatus Shifts to Power Saving Mode>

### (1) Operating Sequences

Next, the ordinary operating sequences in key exchange control processing of each layer after the communication apparatus A and the communication apparatus B shift to power saving mode in the wireless network A will now be described.

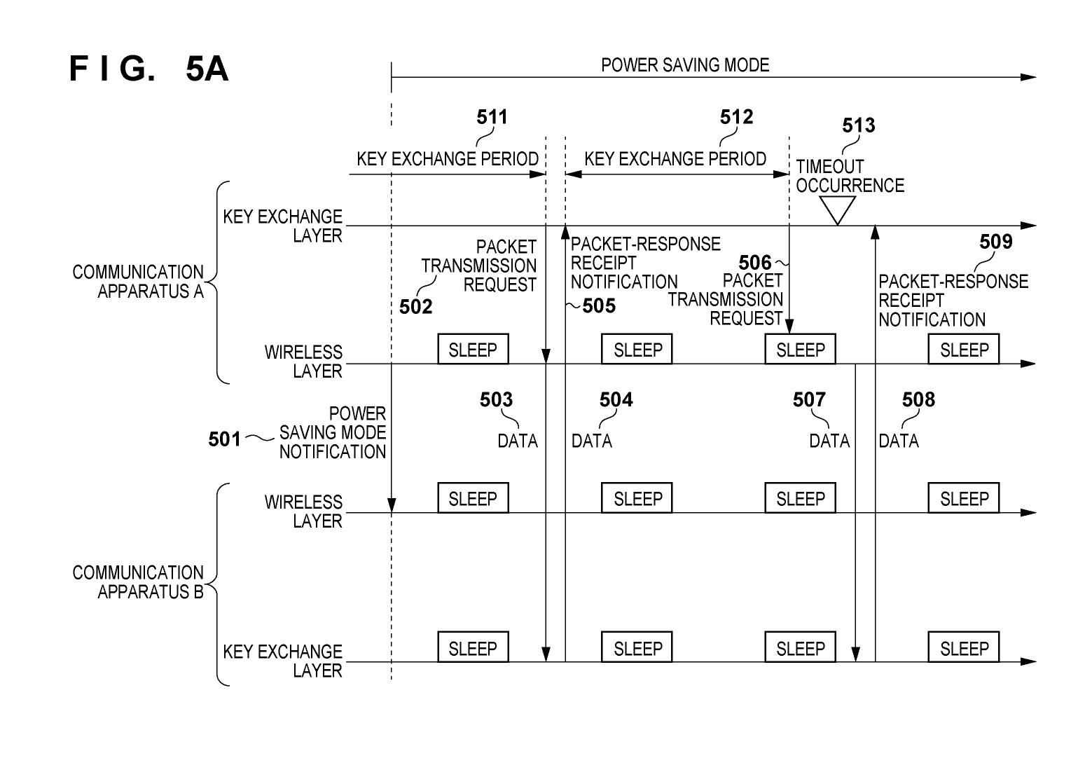

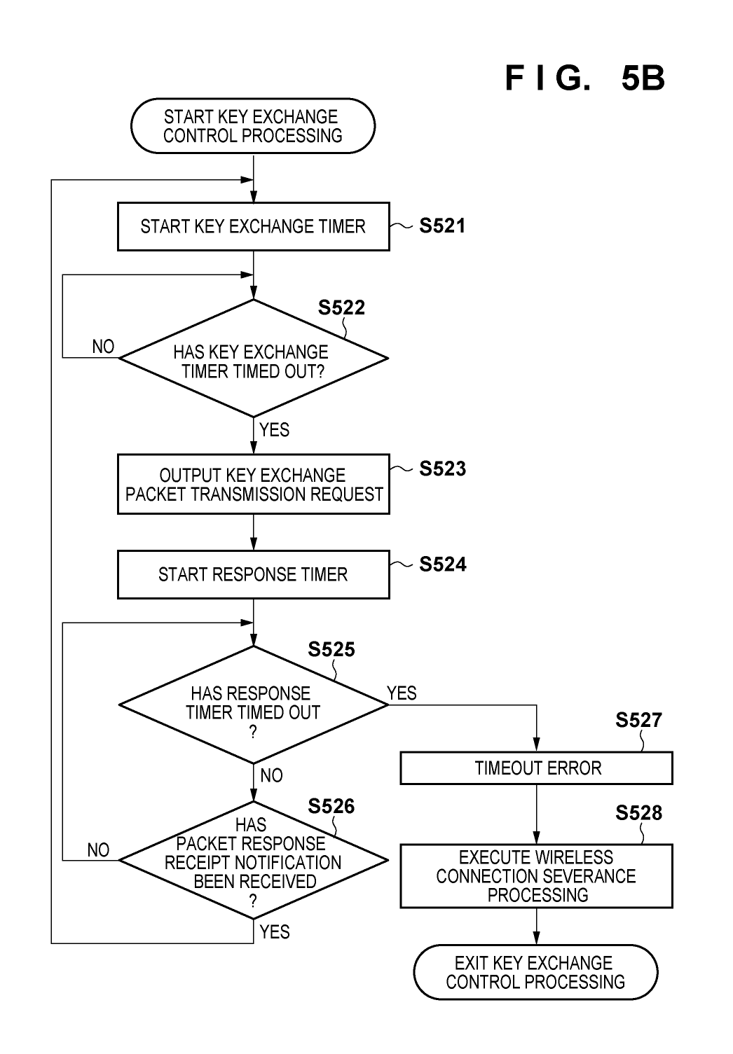

FIG. 5A is a diagram illustrating ordinary operating sequences in key exchange control processing in a case where the communication apparatus A and the communication apparatus B have each been divided into a wireless layer and a layer (key exchange layer) of an encryption key exchange protocol higher than the wireless layer in the wireless network A.

When a shift is made to the power saving mode, first the communication apparatus A serving as the base station transmits power saving mode notification 501 to the communication apparatus B serving as the terminal station, as mentioned above.

It should be noted that it is assumed that the power saving mode notification 501 includes various parameters relating to power saving processing, such as “sleep time” indicating the length of a single instance of the sleep state of each communication apparatus and a “power saving interval” indicating the interval between one instance of the sleep state and the next instance thereof.

Even after a shift is made to the power saving mode, key exchange control processing is executed periodically in the key exchange layer of the communication apparatus A. Specifically, whenever key exchange periods 511, 512 end, the key exchange layer outputs key exchange packet transmission requests 502, 506 to the wireless layer of the communication apparatus A.

Since the wireless layer of the communication apparatus A is in the normal state at the timing at which the key exchange layer outputs the key exchange packet transmission request 502, the wireless layer transmits data 503 (a key exchange packet) to the communication apparatus B as is at this timing.

Upon receiving the data 503 from the communication apparatus A, the communication apparatus B transmits data 504 (a key exchange packet) to the communication apparatus A as a response to the key exchange packet from the communication apparatus A. The wireless layer of the communication apparatus A discriminates that the data 504 received from the communication apparatus B is a key exchange packet and outputs packet-response receipt notification 505 to the key exchange layer.

The key exchange layer of the communication apparatus A starts the next key exchange period 512 using receipt of the packet-response receipt notification 505 as a trigger. Further, when the packet-response receipt notification 505 is received, encryption-key exchange control processing continues between the key exchange layer of the communication apparatus A and the key exchange layer of the communication apparatus B. This encryption-key exchange control processing, which is key exchange control processing that is based upon the WPA (registered trademark) specifications and the IEEE 802.11i specifications, performs random-number generation and exchange and generates an encryption key utilizing the exchanged random number. When the key exchange period 512 ends, the key exchange layer of the communication apparatus A outputs key exchange packet transmission request 506 again to the wireless layer.

Since the wireless layer of the communication apparatus A is in the sleep state at the timing at which the key exchange layer outputs the packet transmission request 506, the wireless layer does not transmit data at this time. The wireless layer waits until the transition is made to the normal state. When the transition is made to the normal state, the wireless layer of the communication apparatus A transmits data 507 (a key exchange packet) to the communication apparatus B.

Upon receiving the data 507 from the communication apparatus A, the communication apparatus B transmits data 508 (a key exchange packet) to the communication apparatus A as a response to the key exchange packet from the communication apparatus A. The wireless layer of the communication apparatus A discriminates that the data 508 received from the communication apparatus B is a key exchange packet and outputs packet-response receipt notification 509 to the key exchange layer.

However, at the time that the packet-response receipt notification 509 is received, timeout has already occurred (513) in the key exchange layer of the communication apparatus A. As a consequence, the wireless connection between the communication apparatus A and the communication apparatus B is severed.

### (2) Processing Flow

Next, in key exchange control processing, the flow of processing in the key exchange layer of communication apparatus A will be described. This layer is one of the layers that operate according to the ordinary operating sequence described above.

FIG. 5B is a diagram illustrating the flow of processing in the key exchange layer of communication apparatus A. This layer operates according to the ordinary operating sequence described above.

A key exchange timer is started at step S521. Specifically, a timer starts counting based upon the key exchange period to which the communication apparatus A has been preset.

Whether the key exchange timer has timed out is determined at step S522. If it is determined at step S522 that the key exchange timer has not timed out, then timeout is awaited. If it is determined at step S522 that the key exchange timer has timed out, on the other hand, then control proceeds to step S523 and a key exchange packet transmission request is output to the wireless layer. A response timer starts counting at step S524.

Whether the response timer has timed out is determined at step S525. If it is determined at step S522 that the response timer has not timed out, control proceeds to step S526, where it is determined whether packet-response receipt notification has been received. If it is determined at step S526 that packet-response receipt notification has not been received, control returns to step S525 and it is determined whether the response timer has timed out. If it is determined at step S526 that the packet-response receipt notification has been received, on the other hand, then control returns to step S521 to begin the next key exchange period, and counting of the key exchange timer is started. It should be noted that if the packet-response receipt notification is received, random-number generation and exchange and generation of an encryption key utilizing the random number are carried out as mentioned earlier.

On the other hand, if it is determined at step S525 that the response timer has timed out, control proceeds to step S527, where it is judged that timeout error has occurred. In this case, the key exchange layer ends key exchange control processing after the wireless layer is instructed to execute processing for severing the wireless connection at step S528.

As will be evident from the foregoing description, in accordance with the ordinary operating sequence and processing flow thereof in key exchange control processing, the wireless connection between communication apparatuses is severed if timeout occurs at the time at which the packet response receipt notification is received. The probability that such timeout will occur rises when only the key exchange layer operates and the wireless layer is in the sleep state.

The reason for this is that in the case of an ordinary communication apparatus, the wireless layer and the key exchange layer operate independently of each other. Accordingly, in the communication apparatus according to this embodiment, it is arranged so that the key exchange period in the key exchange layer is changed in accordance with the state (the sleep state or the normal state) of the wireless layer for the purpose of avoiding severance of the wireless connection ascribable to occurrence of timeout in the power saving mode. The operating sequences in key exchange control processing and the flow of processing in the key exchange layer according to the communication apparatus of this embodiment will now be described.

<6. Operating Sequences and Processing Flow in Key Exchange Control Processing of Each Layer After Each Communication Apparatus Shifts to Power Saving Mode According to this Embodiment>

### (1) Operating Sequences

First, the operating sequences according this embodiment of each layer after the communication apparatus A and the communication apparatus B shift to power saving mode in the wireless network A will be now described.

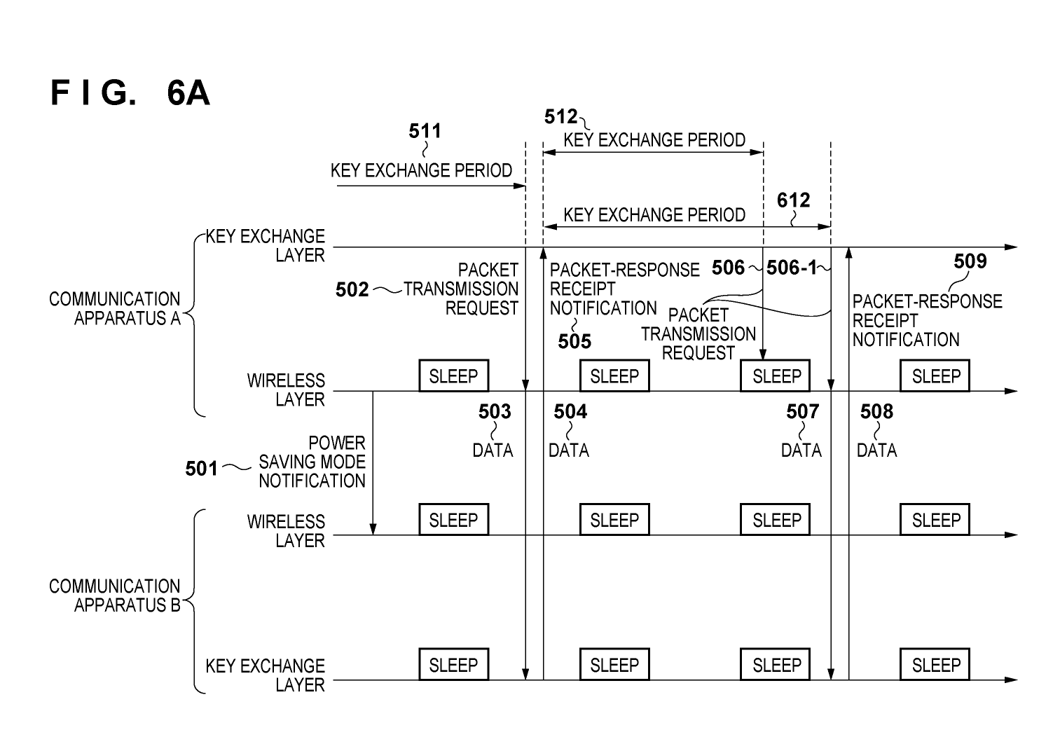

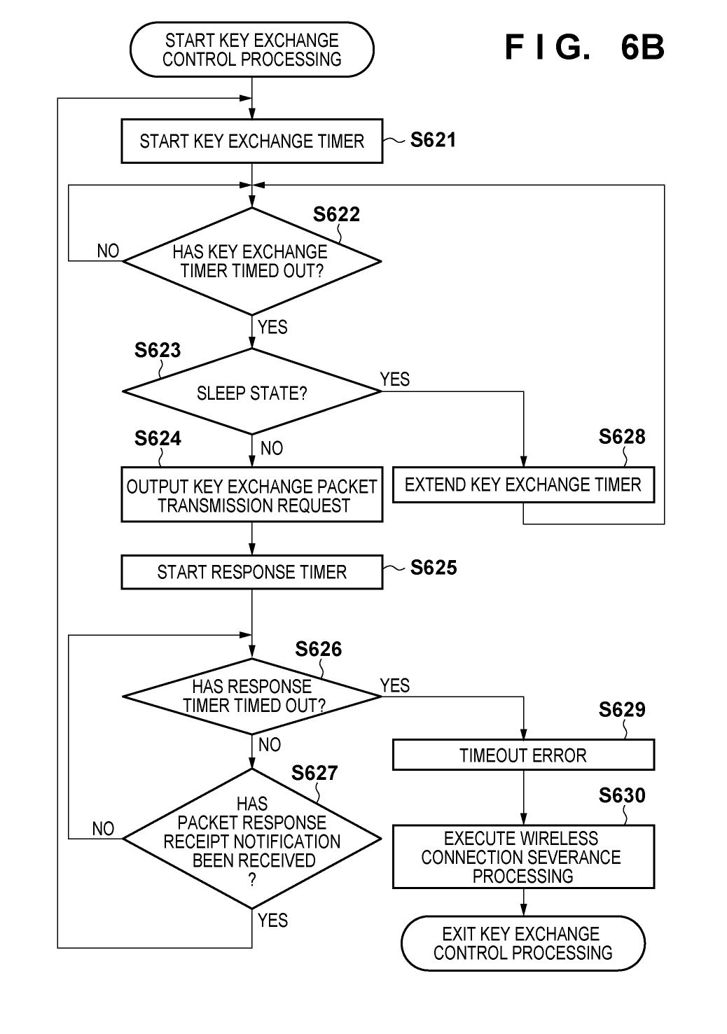

FIG. 6A is a diagram illustrating operating sequences in this embodiment in key exchange control processing in a case where the communication apparatus A and the communication apparatus B have each been divided into a wireless layer and a key exchange layer in the wireless network A. Elements in FIG. 6A similar to those in FIG. 5A are designated by like reference characters and need not be described again. The description below will focus how FIG. 6A differs from FIG. 5A.

When the key exchange period 512 ends and the key exchange layer of the communication apparatus A outputs the key exchange packet transmission request 506 again, the wireless layer of the communication apparatus A is in the sleep state at this timing and therefore the wireless layer does not transmit data. Accordingly, when the key exchange layer recognizes that the wireless layer is in the sleep state, the key exchange layer extends the key exchange period (see 612). The extended time of the key exchange timer is a fixed extension of time set in advance. If the key exchange layer again recognizes that the wireless layer is in the sleep state after the extended period of time elapses, it will suffice to extend the key exchange period again. Further, it may be arranged so that the time extension is made in conformity with the time at which sleep time ends, with the key exchange timer timing out when sleep time ends and the normal state is attained.

The key exchange timer in which time has thus been extended subsequently times out after the wireless layer transitions to the normal state, and the key exchange layer outputs a key exchange packet transmission request 506-1 to the wireless layer. Upon receiving the key exchange packet transmission request 506-1 from the key exchange layer, the wireless layer transmits data 507 (the key exchange packet) to the communication apparatus B.

Upon receiving the data 507 from the communication apparatus A, the communication apparatus B transmits data 508 (a key exchange packet) to the communication apparatus A as a response to the key exchange packet from the communication apparatus A. The wireless layer of the communication apparatus A discriminates that the data 508 received from the communication apparatus B is a key exchange packet and outputs packet-response receipt notification 509 to the key exchange layer.

This time timeout does not occur in the key exchange layer of the communication apparatus A because the key exchange period 612 has been extended. As a result, the key exchange layer can receive the packet-response receipt notification 509 and performs random-number generation and exchange and generates an encryption key utilizing the exchanged random number. Further, the wireless connection between the communication apparatus A and the communication apparatus B is maintained.

### (2) Processing Flow

Next, in key exchange control processing, the flow of processing in the key exchange layer of the communication apparatus A will be described. This is a layer that operates according to the operating sequence shown in FIG. 6A. FIG. 6B is a diagram illustrating the flow of processing in the key exchange layer of communication apparatus A. This is a layer that operates according to the operating sequence shown in FIG. 6A.

A key exchange timer is started at step S621. Specifically, a timer starts counting based upon the key exchange period to which the communication apparatus A has been preset.

Whether the key exchange timer has timed out is determined at step S622. If it is determined at step S622 that the key exchange timer has not timed out, then timeout is awaited. If it is determined at step S622 that the key exchange timer has timed out, on the other hand, then control proceeds to step S623 and it is determined whether the wireless layer is in the sleep state (doze state).

If it is determined at step S623 that the wireless layer is in the normal state (awake state) and not the sleep state, then control proceeds to step S624 and a key exchange packet transmission request is output to the wireless layer in a manner similar to that in FIG. 5B.

If it is determined at step S623 that the wireless layer is in the sleep state, on the other hand, then control proceeds to step S628 and the time in the key exchange timer is extended. If it is determined that the extended key exchange timer has timed out, control proceeds to step S623 and the processing described above is executed.

After the key exchange packet transmission request is output at step S624, the response timer starts counting at step S625.

Whether the response timer has timed out is determined at step S626. If it is determined at step S626 that the response timer has not timed out, control proceeds to step S627, where it is determined whether packet-response receipt notification has been received. If it is determined at step S627 that packet-response receipt notification has not been received, control returns to step S626 and it is determined whether the response timer has timed out. If it is determined at step S627 that the packet-response receipt notification has been received, on the other hand, then control returns to step S621 to begin the next key exchange period, and counting of the key exchange timer is started.

On the other hand, if it is determined at step S626 that the response timer has timed out, control proceeds to step S629, where it is judged that timeout error has occurred. In this case, the key exchange layer ends key exchange control processing after the wireless layer is instructed to execute processing for severing the wireless connection at step S630.

Thus, in a case where the wireless layer is in the sleep state at the timing at which a key exchange packet is transmitted, the key exchange period is extended and the start of counting in the response timer is delayed, thereby making it possible to avoid severance of the wireless connection due to timeout in the response timer.

In other words, in accordance with the communication apparatus according to this embodiment, if a packet is transmitted periodically by key exchange control processing, it is possible for execution of this key exchange control processing to continue without conflict with a sleep state established by a power saving mode.

### Second Embodiment

In the first embodiment set forth above, it is described that the key exchange period is the same preset value throughout. However, the present invention is not limited to this arrangement and it goes without saying that the invention is applicable also to a case where the key exchange period is variable and is increased or decreased each time.

Further, in the first embodiment, the layer higher than the wireless layer is described as being the key exchange layer. However, the higher layer is not limited to the key exchange layer. For example, the higher layer can be a layer in which addressing such as DHCP or AutoIP or a discovery protocol such as UPnP or mDNS is executed. Alternatively, the higher layer may be another layer if it is a layer in which a protocol having a timeout is executed. In the case of a discovery protocol, a characterizing feature is that the time in a protocol timer increases monotonously with the number of times communication is performed. The present invention is applicable to such a protocol as well.

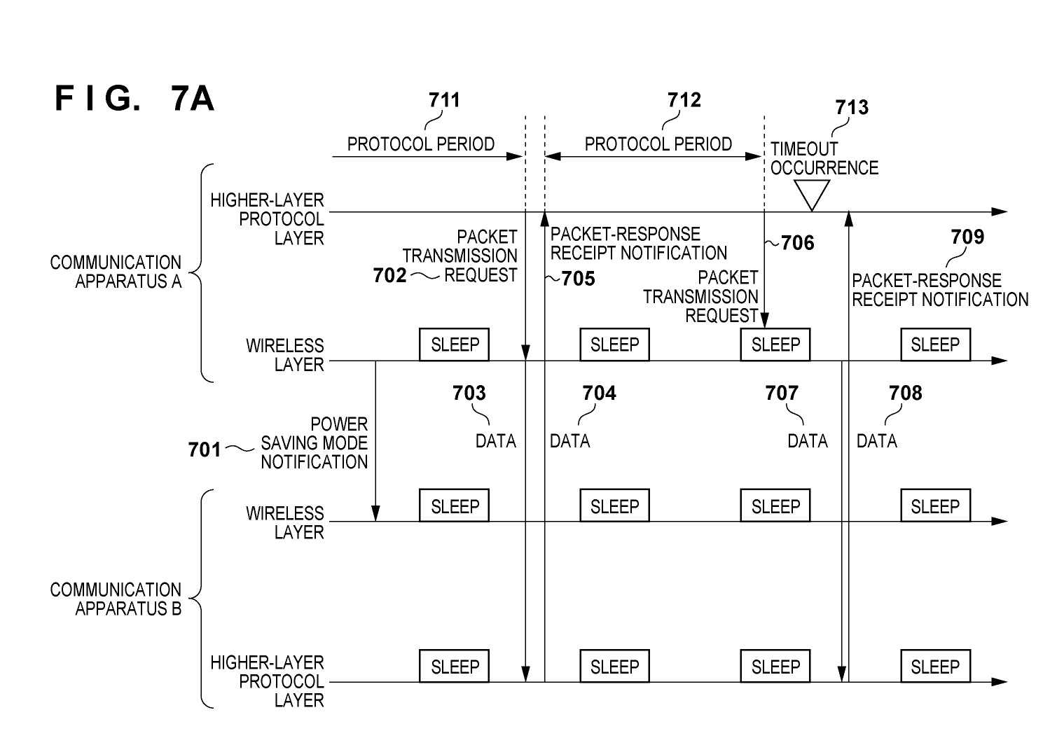

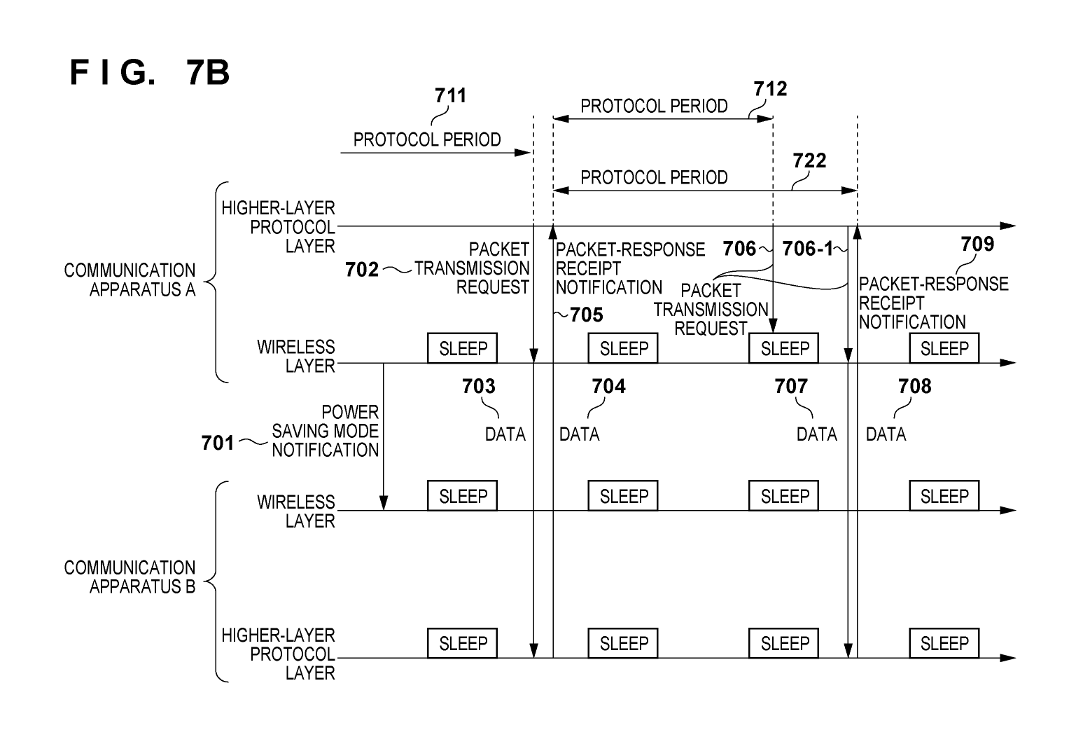

FIGS. 7A, 7B are diagrams illustrating operating sequences that accompany control processing in every layer (inclusive of a layer in which a protocol having a timeout is executed) after a shift is made to the power saving mode in each communication apparatus according to this embodiment. (For the purpose of contrast, an ordinary operating sequence is shown as well.)

By adopting an arrangement in which the protocol period is extended as necessary (see FIG. 7B) where timeout occurred in the ordinary operating sequence (see FIG. 7A), it is possible to avoid the occurrence of timeout in a manner similar to the case of key exchange control processing.

### Third Embodiment

In the first and second embodiments set forth above, an arrangement is adopted in which, in order to avoid the occurrence of timeout, a prescribed protocol period such as a key exchange period is changed in accordance with the state of the wireless layer at the time of output of a packet transmission request.

However, the present invention is not limited to this arrangement. For example, an arrangement may be adopted in which the state of the wireless layer at the time of output of a packet transmission request is predicted and the wireless layer changes the transmission timing of the key exchange packet accordingly. The details of this embodiment will be described below. It should be noted that the hardware configuration and functional configuration of the communication apparatus and the wireless network configuration in this embodiment are similar to those of the first and second embodiments and need not be described again.

### <1. Ordinary Processing Flow in Wireless Layer in Key Exchange Control Processing After Each Communication Apparatus Shifts to Power Saving Mode>

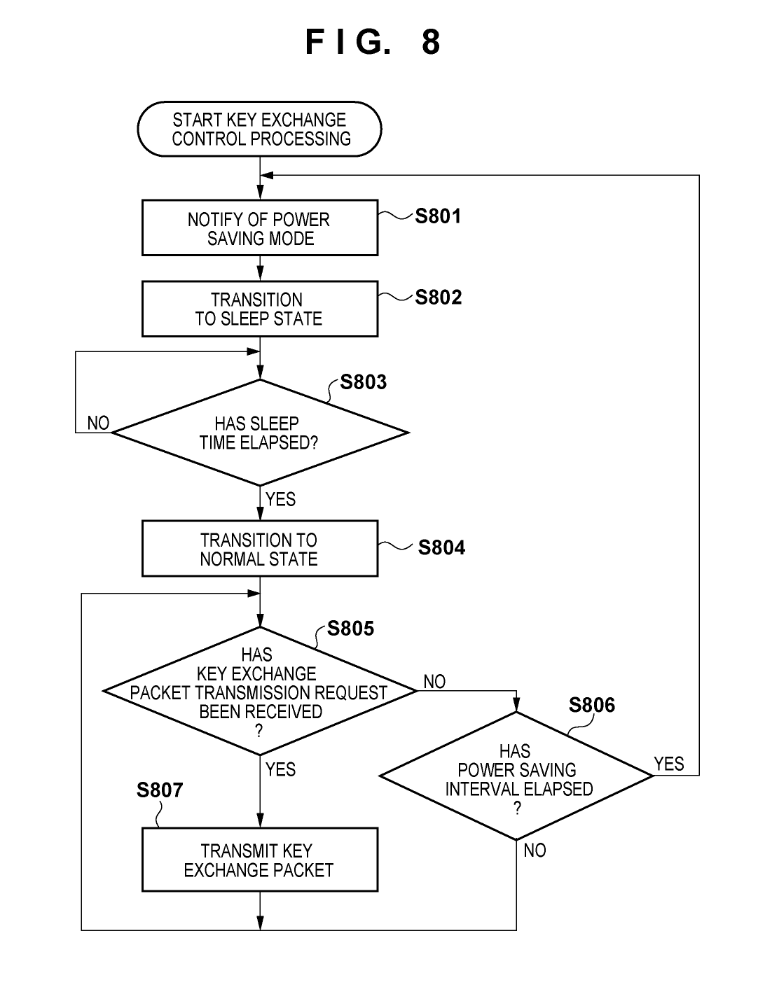

First, the ordinary flow of processing in the wireless layer of communication apparatus A will be described. This is one of the layers that operate in key exchange control processing. FIG. 8 is a diagram illustrating the ordinary flow of processing in the wireless layer of communication apparatus A. This layer operates in key exchange control processing.

At step S801, notification of the power saving mode is transmitted to the communication apparatus B in order to effect a shift to the power saving mode. It should be noted that it is assumed that the power saving mode notification transmitted from the communication apparatus A includes various parameters relating to power saving processing, such as “sleep time” indicating the length of a single instance of the sleep state of each communication apparatus and a “power saving interval” indicating the interval between one instance of the sleep state and the next instance thereof.

When the power saving mode notification is transmitted to the communication apparatus B, a transition is made to the sleep state (doze state) at step S802.

At step S803, it is determined whether the sleep time period has elapsed following the transition of the sleep state. If it is determined at step S803 that the sleep time period has not elapsed, then elapse is awaited. On the other hand, if it is found at step S803 that the sleep time period has elapsed, control proceeds to step S804 and a transition is made from the sleep state (doze state) to the normal state (awake state) (step S804).

After the transition is made to the normal state, it is determined at step S805 whether a key exchange packet transmission request has been received from the key exchange layer. The determination as to whether the key exchange packet transmission request has been received from the key exchange layer is carried out until the length of time of the power saving interval elapses following the transition to the normal state (step S806). When the length of time of the power saving interval elapses and the timing for transition to the next instance of the sleep state arrives, control returns to step S802 so that the sleep state is attained again.

On the other hand, if it is determined at step S805 that the key exchange packet transmission request has been received from the key exchange layer, then the key exchange packet is transmitted to the communication apparatus B at step S807. After the key exchange packet is transmitted, control returns to step S805 in order to ascertain whether untransmitted key exchange packets exist. When a response is received from the communication apparatus B after the key exchange packet is transmitted to the communication apparatus B, the wireless layer notifies the key exchange layer of receipt of the key exchange packet.

In a case where transmission of a key exchange packet has been performed by the processing flow set forth above, a time lag will develop by the time the key exchange packet is transmitted to the communication apparatus B if the wireless layer is in the sleep state at the timing at which the key exchange period times out. As a result, the probability that timeout will occur rises in the key exchange layer

Accordingly, in the communication apparatus of this embodiment, an arrangement is adopted in which when a transition is made to the sleep state in the power saving mode, the time that remains until the present key exchange period times out is acquired and the transition to the sleep state is made upon transmission of a key exchange packet in accordance with the time acquired. The processing flow in a wireless layer having this configuration will be described below.

<2. Processing Flow in Wireless Layer in Key Exchange Control Processing After Each Communication Apparatus Shifts to Power Saving Mode According to this Embodiment>

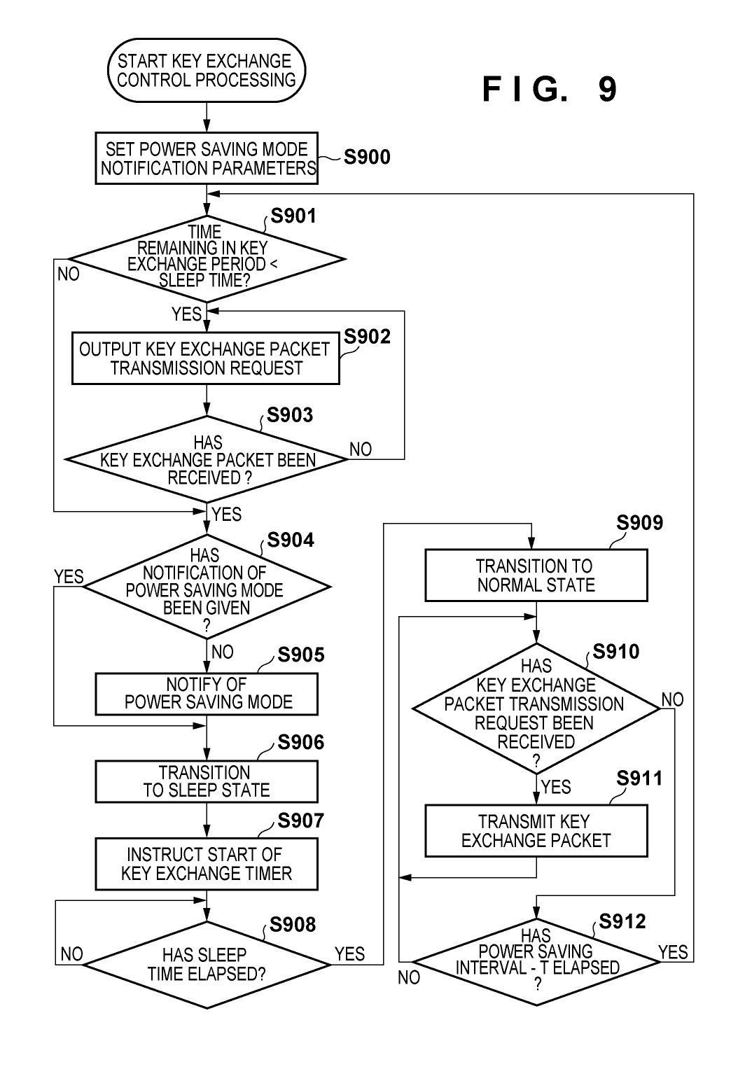

FIG. 9 is a diagram illustrating processing flow in a wireless layer and key exchange layer in which when a transition is made to the sleep state in the power saving mode, the time that remains until the present key exchange period times out is acquired and the transition to the sleep state is made upon transmission of a key exchange packet in accordance with the time acquired.

At step S900, the wireless layer sets various parameters that will be included in a power saving mode notification that the communication apparatus A transmits to the communication apparatus B. It should be noted that it is assumed that the power saving mode notification includes parameters relating to power saving processing, such as “sleep time” indicating the length of a single instance of the sleep state of each communication apparatus and a “power saving interval” indicating the interval between one instance of the sleep state and the next instance thereof. The wireless layer notifies the key exchange layer of the content of the set power saving mode.

At step S901, before the communication apparatus A transitions to the sleep state, the key exchange layer compares sleep time and the time remaining in the key exchange period.

In a case where it is determined that the time remaining in the key exchange period is less (shorter) than sleep time, the wireless layer will have transitioned to the sleep state at the timing of key exchange of the key exchange period if the transition to the sleep state is made as is. For this reason, the transition to the sleep state is made after transmission of the key exchange packet is performed first.

More specifically, at step S902, the key exchange layer outputs the key exchange packet transmission request to the wireless layer and the wireless layer transmits the key exchange packet to the communication apparatus B. At step S903, the key exchange layer waits until a key exchange packet is received from the communication apparatus B as a response by the communication apparatus B. It should be noted that in a case where the key exchange packet is not received within a prescribed period of time, the key exchange packet transmission request is re-sent a number of times predetermined by the communication protocol in the wireless layer.

If the key exchange layer receives the key exchange packet from the communication apparatus B at step S903, it is judged that the key exchange ended normally and the wireless layer is notified of this fact. Upon receiving this notification from the key exchange layer, the wireless layer determines at step S904 whether the power saving mode notification has been transmitted to the communication apparatus B. If such notification of the power saving mode has been transmitted, control proceeds to step S906. If notification of the power saving mode has not been transmitted, then notification of the power saving mode is transmitted to the communication apparatus B at step S905 and then control proceeds to step S906.

This communication apparatus also transitions to the sleep mode at step S906. It is assumed that the power saving mode notification includes various parameters relating to power saving processing, such as “sleep time” and “power saving interval” set at step S900.

At step S907, the wireless layer instructs the key exchange layer to start the key exchange timer, and the key exchange layer starts the key exchange timer.

At step S908, it is determined whether the sleep time period has elapsed following the transition to the sleep state. If it is determined at step S908 that sleep time has not yet elapsed, then elapse is awaited. On the other hand, if it is found that the sleep time period has elapsed, then a transition is made from the sleep state (doze state) to the normal state (awake state) at step S909.

After the transition is made to the normal state, at step S910 the wireless layer verifies whether a key exchange packet transmission request has been received from the key exchange layer. The determination as to whether the key exchange packet transmission request has been received from the key exchange layer is carried out until a length of time (power saving interval −T), which is obtained by subtracting a prescribed time period (T) from the length of time of the power saving interval, elapses following the transition to the normal state (step S912). The prescribed time period T is long enough for key exchange packets to be sent and received between the communication apparatus A and communication apparatus B. When the length of time (power saving interval −T) elapses, control returns to step S901 in order that the transition to the sleep state is made again.

If it is determined at step S910 that the wireless layer has received the key exchange packet transmission request from the key exchange layer, then the wireless layer transmits the key exchange packet to the communication apparatus B at step S911.

After the key exchange packet is transmitted, control returns to step S910 in order to ascertain whether untransmitted key exchange packets exist. When a response is received from the communication apparatus B after the key exchange packet is transmitted to the communication apparatus B, the wireless layer notifies the key exchange layer of receipt of the key exchange packet.

Thus, in the communication apparatus of this embodiment, an arrangement is adopted in which when a transition is made to the sleep state in the power saving mode, the length of time up to the timing of the key exchange of the key exchange period is acquired and the transition to the sleep state is made upon transmission of a key exchange packet in accordance with the time acquired. As a result, it is possible to avoid severance of the wireless connection due to due timeout of the key exchange timer.

In other words, in accordance with the communication apparatus according to this embodiment, if a packet is transmitted periodically by key exchange control processing, it is possible for execution of this key exchange control processing to continue without conflict with a sleep state established by a power saving mode.

### Fourth Embodiment

In the third embodiment set forth above, it is described that the key exchange period is the same preset value. However, the present invention is not limited to this arrangement and it goes without saying that the invention is applicable also to a case where the key exchange period is variable and is increased or decreased every cycle, by way of example.

Further, in the third embodiment, the layer higher than the wireless layer is described as being the key exchange layer. However, the higher layer is not limited to the key exchange layer. For example, the higher layer can be a layer in which addressing such as DHCP or AutoIP or a discovery protocol such as UPnP or mDNS is executed. Alternatively, the higher layer may be another layer if it is a layer in which a protocol having a timeout is executed. In the case of a discovery protocol, a characterizing feature is that the time in a protocol timer increases monotonously with the number of times communication is performed. The present invention is applicable to such a protocol as well.

### Fifth Embodiment

In the third and fourth embodiments set forth above, an arrangement is adopted in which, in order to avoid the occurrence of timeout, the state of the wireless layer at the time of output of a packet transmission request in the power saving mode is predicted and the wireless layer changes the transmission timing of the key exchange packet accordingly. However, the present invention is not limited to this arrangement.

For example, an arrangement may be adopted in which the state of the wireless layer at the time of output of a packet transmission request in the power saving mode is predicted and the wireless layer changes the length of power saving time accordingly. Further, an arrangement may be adopted in which a parameter relating to power saving processing of which another communication apparatus is notified is changed at this time. The details of this embodiment will be described below. It should be noted that the hardware configuration and functional configuration of the communication apparatus and the wireless network configuration in this embodiment are similar to those of the first to fourth embodiments and need not be described again.

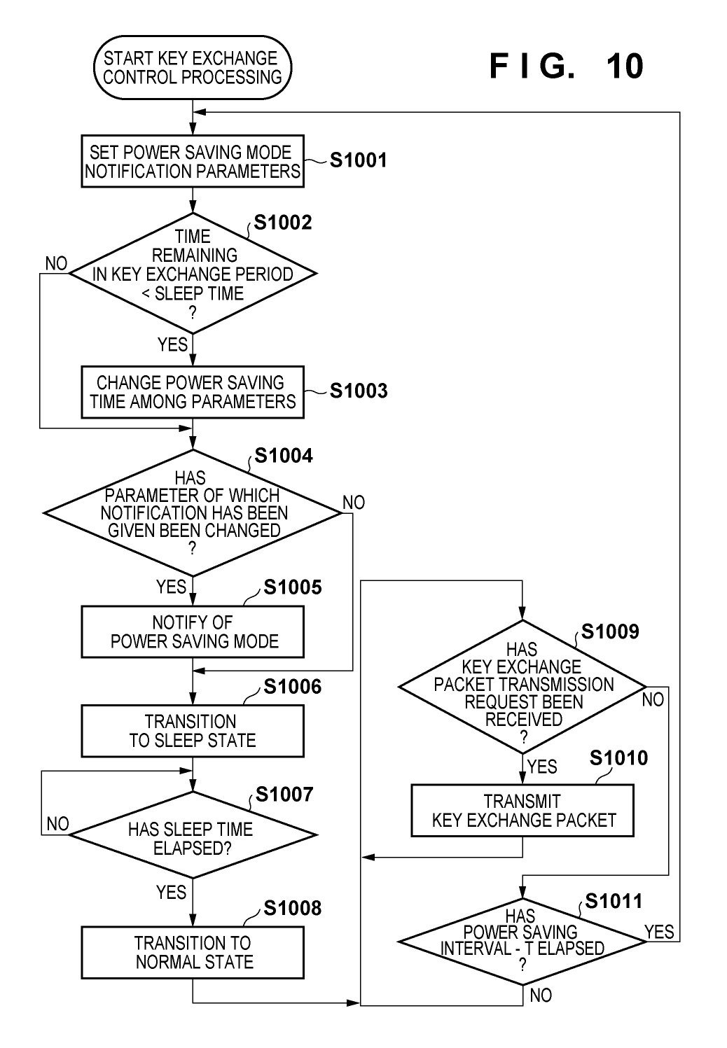

FIG. 10 is a diagram illustrating processing flow in a wireless layer in which when a transition is made to the sleep state in the power saving mode, the length of time up to the timing of the key exchange of the key exchange period is acquired and the sleep time is changed in accordance with the time acquired.

At step S1001, various parameters that will be included in a power saving mode notification that the communication apparatus A transmits to the communication apparatus B are set to predetermined default values. It should be noted that it is assumed that the power saving mode notification includes parameters relating to power saving processing, such as “sleep time” indicating the length of a single instance of the sleep state of each communication apparatus and a “power saving interval” indicating the interval between one instance of the sleep state and the next instance thereof.

At step S1002, before the communication apparatus A transitions to the sleep state, the set sleep time and the time remaining in the key exchange period are compared when the transition is made to the sleep state (namely a prescribed period of time before the transition is made to the sleep state). It should be noted that “a prescribed period of time before the transition is made to the sleep state ” is a time long enough for key exchange packets to be sent and received between the communication apparatus A and communication apparatus B.

In a case where it is determined that the time remaining in the key exchange period is shorter than power saving time, the wireless layer will have transitioned to the sleep state at the timing of key exchange of the key exchange period if the transition to the sleep state is made as is. At step S1003, therefore, a parameter setting is changed in such a manner that sleep time will be shorter than the length of time that was set at step S1001. Control then proceeds to step S1004. Sleep time is changed by being shortened in such a manner that at the transmission timing of the next key exchange packet, the sleep state will end and the transition to the normal state will be attained.

On the other hand, in a case where it is determined at step S1002 that the time remaining in the key exchange timer is longer than power saving time, the parameters relating to power saving processing remain at the values set at step S1001 and control proceeds to step S1004.

At step S1004, it is determined whether a parameter relating to power saving processing has been changed from the content of the power saving mode notification sent last to the communication apparatus B. In a case where power saving mode notification has not been sent to the communication apparatus B and in a case where a parameter has been changed from the content of which notification was given last, the power saving mode notification is transmitted to the communication apparatus B at step S1005. After the power saving mode notification is transmitted, a transition is made to sleep state (doze state) at step S1006.

At step S1007, it is determined whether the sleep time period has elapsed following the transition to the sleep state. If it is determined at step S1007 that sleep time has not yet elapsed, then elapse is awaited. On the other hand, if it is found that the sleep time period has elapsed, then control proceeds to step S1008 and a transition is made from the sleep state (doze state) to the normal state (awake state).

After the transition is made to the normal state, at step S1009 the wireless layer verifies whether a key exchange packet transmission request has been received from the key exchange layer. The determination as to whether the key exchange packet transmission request has been received from the key exchange layer is carried out until a length of time (power saving interval −T), which is obtained by subtracting prescribed time period (T) from the length of time of the power saving interval, elapses following the transition to the normal state (step S1011). The prescribed time period T is long enough for key exchange packets to be sent and received between the communication apparatus A and communication apparatus B. When the length of time (power saving interval −T) elapses, control returns to step S1001 in order that the transition to the sleep state is made again.

If it is determined at step S1009 that the wireless layer has received the key exchange packet transmission request from the key exchange layer, then the wireless layer transmits the key exchange packet to the communication apparatus B at step S1010.

After the key exchange packet is transmitted, control returns to step S1009 in order to ascertain whether untransmitted key exchange packets exist. When a response is received from the communication apparatus B after the key exchange packet is transmitted to the communication apparatus B, the wireless layer notifies the key exchange layer of receipt of the key exchange packet.

Thus, in the communication apparatus of this embodiment, an arrangement is adopted in which when a transition is made to the sleep state in the power saving mode, the length of time up to the timing of the key exchange of the key exchange period is acquired and the sleep time period is changed in accordance with the time acquired. As a result, the time at which the transition to the normal state is made is changed and it is possible to avoid severance of the wireless connection due to due timeout of the key exchange timer.

In other words, in accordance with the communication apparatus according to this embodiment, if a packet is transmitted periodically by key exchange control processing that is executed periodically, it is possible for execution of this key exchange control processing to continue without conflict with a sleep state established by a power saving mode.

### Sixth Embodiment

In the third embodiment set forth above, it is described that the key exchange period is the same preset value. However, the present invention is not limited to this arrangement and it goes without saying that the invention is applicable also to a case where the key exchange period is variable and is increased or decreased each time, by way of example.

In the fifth embodiment, the layer higher than the wireless layer is described as being the key exchange layer. However, the higher layer is not limited to the key exchange layer. For example, the higher layer can be a layer in which addressing such as DHCP or AutoIP or a discovery protocol such as UPnP or mDNS is executed. Alternatively, the higher layer may be another layer if it is a layer in which a protocol having a timeout is executed. In the case of a discovery protocol, a characterizing feature is that the time in a protocol timer increases monotonously with the number of times communication is performed. The present invention is applicable to such a protocol as well.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2010-224371 filed Oct. 1, 2010 and 2011-155950 filed Jul. 14, 2011 which are hereby incorporated by reference herein in their entirety.

What is claimed is:

1. A communication apparatus comprising:
a power saving unit configured to cause a wireless communication section to transition to a power saving state and an awake state periodically;
a communication unit configured to execute wireless communication by a prescribed protocol periodically; and
a changing unit configured to change, in accordance with execution timing at which wireless communication by the prescribed protocol is executed periodically and transition timing at which the wireless communication section is caused to transition from the power saving state to the awake state, either the execution timing or the transition timing before wireless communication by the prescribed protocol is executed periodically.

2. The apparatus according to claim 1, wherein the prescribed protocol is a key exchange protocol or a discovery protocol that includes addressing.

3. The apparatus according to claim 1, wherein said changing unit extends the execution timing in a case where the execution timing overlaps the time period of the power saving state of the wireless communication section.

4. The apparatus according to claim 1, wherein a prescribed period of time before the execution timing, said changing unit compares a time period that extends up to the execution timing with a time period that extends from a transition to the power saving state to a transition to the awake state, and in accordance with the result of the comparison, changes the execution timing before the transition to the power saving state is made.

5. The apparatus according to claim 4, wherein said changing unit changes the execution timing before the transition to the power saving state is made in a case where the time period that extends up to the execution timing is shorter than the time period that extends from the transition to the power saving state to the transition to the awake state.

6. The apparatus according to claim 1, wherein a prescribed period of time before the execution timing, said changing unit compares a time period that extends up to the execution timing with a time period that extends from a transition to the power saving state to a transition to the awake state, and in accordance with the result of the comparison, changes a time period that extends from the transition to the power saving state to the transition to the awake state.

7. The apparatus according to claim 6, wherein said changing unit shortens the time period that extends from the transition to the power saving state to the transition to the awake state in a case where the time period that extends up to the execution timing is shorter than the time period that extends from the transition to the power saving state to the transition to the awake state.

8. A method of controlling a communication apparatus, comprising:
a power saving step of causing a wireless communication section to transition to a power saving state and an awake state periodically;
an execution step of executing wireless communication by a prescribed protocol periodically; and
a changing step of changing, in accordance with execution timing at which wireless communication by the prescribed protocol is executed periodically and transition timing at which the wireless communication section is caused to transition from the power saving state to the awake state, either the execution timing or the transition timing before wireless communication by the prescribed protocol is executed periodically.

9. A computer-readable storage medium storing a program for causing a computer to execute the steps of the control method set forth in claim 8.
